(19) United States
(12) Patent Application Publication
(10) Pub. No.: US 2012/0307639 A1
(43) Pub. Date: Dec. 6, 2012

(54) Method and Device for Data Processing in a Network

(76) Inventors: Wolfgang Zirwas, Munchen (DE); Bernhard Wegmann, Holzkirchen (DE)

(21) Appl. No.: 13/518,643

(22) PCT Filed: Dec. 22, 2009
(86) PCT No.: PCT/EP2009/067785

§ 371 Date: Jul. 30, 2012

(51) Int. Cl. H04W 28/08; H04W 72/04

(52) U.S. Cl. 370/236; 370/329

(57) ABSTRACT

A method and a device for data processing in a network is provided, wherein a centralized network component adjusts a coordinated multipoint transmission of cells of the network based on information provided by the network and/or by said cells. Furthermore, a communication system is suggested including said device.

The invention relates to a method and to a device for data processing in a network. Further, a communication system is suggested comprising at least one such device.

For LTE Advanced (LTE-A), a so-called coordinated multi point (CoMP) transmission is a study item with the goal to overcome inter cell interference limitations. High performance gains can be expected from joint precoding solutions, where pre-coded data are simultaneously transmitted from several base stations (eNBs) to several mobile terminals (UEs).

CoMP transmission refers to a coherent multi-cell transmission with several data streams being jointly transmitted over the same radio resources. Since channel state information of all such jointly used links is known and exploited by means of precoding, each link can be decoded in an interference-free manner. Determining the cooperation area and/or choosing a base station (e.g., eNB) that has (or is provided with) functionalities of a central unit (CU) is regarded as an issue of a self-organizing network (SON).

The CoMP approach and in particular CoMP joint pre-coding (JP) promises significant performance gains compared to a conventional single cell transmission due to an efficient interference cancellation. However, CoMP transmission requires, e.g., additional feedback information to be provided from the UEs and it increases backhaul data traffic. Therefore, due to the resources required for CoMP transmission it is used in a restricted way and shall in particular only be utilized in case a significant benefit can be expected.

With regard to the SON, a load balancing mechanism is known as a promising approach to efficiently utilize available network resources. In contrast to CoMP transmission, load balancing does not require additional resources, but it exploits possible load imbalances by, e.g., adapting handover (HO) decisions.

The problem to be solved is to provide an efficient and flexible CoMP transmission.

This problem is solved according to the features of the independent claims. Further embodiments result from the depending claims.

In order to overcome this problem, a method for data processing in a network is provided,
wherein a centralized network function adjusts a coordinated multipoint transmission of cells of the network
based on information provided by the network and/or by said cells.

Said centralized network function may be associated with a centralized network component (e.g., a SON entity) or a centralized network strategy. The centralized network function can be implemented by a centralized network component and/or by several decentralized network elements throughout the network. For example, an adjacent cell may inform another cell of the network about coordinated multipoint (CoMP) transmission or resources, e.g., whether CoMP transmission is already active or could be activated, etc.

Said adjustment of coordinated multipoint transmission may comprise setting up, configuring or changing a coordinated multipoint transmission.

The coordinated multipoint transmission may be regarded as a technique changing (increasing or decreasing) a capacity (re-)distributing traffic throughput.

In particular, the approach enables SON in combination with CoMP transmission in particular in combination with load balancing.

It is noted that said network can be a radio or wireless network (2G, 2.5G, 3G, LTE, LTE-A or any other (upcoming) networks) which serves several wireless cells.

Advantageously, this approach allows CoMP transmission of various CoMP areas that are adjusted, configured or set up by the centralized network function or component of the network. This enables a highly efficient approach beyond single cells of the network having to decide whether or not to enter the CoMP mode. For example, this approach enables processing of load balancing across several cells and/or CoMP areas, in particular in a network wide approach. The approach can be used to flexibly adjust CoMP areas in case of, e.g., moving hot spots of high traffic.

The centralized network function could be realized as at least one entity of the network. It may even be (logically) distributed among several physical entities of the network. The centralized network function may provide a centralized functionality that allows adjusting CoMP transmission throughout the network, in particular by adjusting (configuring, setting up) at least one CoMP area.

CoMP transmission allows turning an overloaded cell into a low loaded cell, which may absorb or pick up additional traffic also from adjacent cells.

It is noted that each cell may comprise at least one base station, e.g., a NodeB, an eNB, or the like.

The centralized network function or component may be (associated with) a radio resource manager (RRM) or an entity associated therewith. Also, any other component with a centralized or decentralized functionality (that may also be distributed among several physical entities) could be utilized as centralized network component.

In an embodiment, the centralized network function adjusts a coordinated multipoint transmission by adjusting at least one coordinated multipoint area.

In another embodiment, each coordinated multipoint area comprises at least two cells.

In a further embodiment, load balancing is conducted between the at least one coordinated multipoint area and its adjacent cell(s).

It is noted that load balancing could also occur between CoMP areas.

As load balancing may be based on load imbalances (e.g., there are cells with low traffic load adjacent to fully loaded cells), a CoMP area may absorb a significant portion of the traffic of the cells that are included in this CoMP area. The CoMP area may comprise an arbitrary number of preferably adjacent cells resulting, e.g., in a zone of continuous coverage. As additional traffic can be processed by the CoMP area, traffic from adjacent cells could be absorbed towards the CoMP area as well, thereby reducing the load of these adjacent cells. The traffic from the adjacent cells may be handed over to the CoMP area.

The approach suggested allows adjusting the CoMP areas based on information provided by the network or by the cells. This allows adjusting the degree of CoMP utilization and considering the high processing efforts required for CoMP transmission in view of the benefit of an increased traffic performance. As the information from the cells and/or the network is processed at the centralized network function, situations throughout the network could be considered prior to adjusting the CoMP transmission, e.g., configuring CoMP areas. In other words, CoMP areas may be set up such that a high benefit due to load balancing can be expected. Hence, the benefit of CoMP transmission can be optimized for the whole network (or a portion thereof).

In a next embodiment, the at least one coordinated multipoint area is adjusted based on network gains.

Such network gains may be conveyed via said information from the cells and/or the network. This allows determining the most suitable CoMP areas for efficient CoMP transmission purposes.

It is also an embodiment that the information comprises at least one of the following:
a current load situation of a cell;
a current load situation of a coordinated multipoint area;
a previous load situation of a cell;
a previous load situation of a coordinated multipoint area;
a potential capacity gain of a coordinated multipoint area;
a size of a coordinated multipoint area;
a set of cells that has been combined or could be combined as a coordinated multipoint area.

The load situation may comprise a capacity of the respective cell and/or set of cells (coordinated multipoint area).

With regard to coordinated multipoint areas, different load situations, gains or capacity information may be determined based on an actual CoMP mode such as fast cell selection (FCS), coordinated beam forming (CB) or joint processing (JP). In such case, several messages may be conveyed, each regarding a particular CoMP mode.

Pursuant to another embodiment, the information is determined by a CoMP area prior to conveying the information to the centralized network function.

For example, depending on the size of the CoMP area, predefined values could be used. Also, a key performance indicator could be used that may be determined when the same cells were in CoMP mode. Further, the CoMP area may enter CoMP transmission and determine the achievable CoMP performance for this CoMP area; such performance may be conveyed towards the centralized network function. In addition, other parameters available at the cells or base stations could be used to determine or derive potential CoMP gains.

According to an embodiment, the information is conveyed towards the centralized network function, in particular via an X2 interface or via an S1 interface.

According to another embodiment, the coordinated multipoint transmission is adjusted based on predefined coordinated multipoint areas.

Predefined CoMP areas may be sets of cells that have been chosen as CoMP areas before or are pre-configured. However, such predefined CoMP areas may be changed or adjusted (even dismissed) by the centralized network function when adjusting CoMP transmission of the network.

In yet another embodiment, the centralized network function requests feedback from cells of a coordinated multipoint area.

Hence, at least one message may be used for the centralized network function to address a particular coordinated multi-point area, e.g., by including the IDs of the cells of this particular coordinated multipoint area.

According to a next embodiment, the cells of a coordinated multipoint area exchange information for organizing the coordinated multipoint area.

Thus, a message could be used to convey information between cells of the coordinated multipoint area. The ID of the cell could be used to determine the address of such a message.

The problem stated above is also solved by a device for data processing in a network, comprising or being associated with a processing unit that is arranged to execute the following step: a coordinated multipoint transmission of cells of the network is adjusted based on information provided by the network and/or by said cells.

It is noted that the steps of the method stated herein may be executable on this processing unit as well.

Pursuant to an embodiment, said device is associated with at least one centralized network function or at least one cell.

According to another embodiment, said device is associated with a radio resource manager of an LTE network.

It is further noted that said processing unit can comprise at least one (in particular several) means that are arranged to execute the steps of the method described herein. The means may be logically or physically separated; in particular several logically separate means could be combined in at least one physical unit.

Said processing unit may comprise at least one of the following: a processor, a microcontroller, a hard-wired circuit, an ASIC, an FPGA, a logic device.

The solution provided herein further comprises a computer program product directly loadable into a memory of a digital computer, comprising software code portions for performing the steps of the method as described herein.

In addition, the problem stated above is solved by a computer-readable medium, e.g., storage of any kind, having computer-executable instructions adapted to cause a computer system to perform the method as described herein.

Furthermore, the problem stated above is solved by a communication system comprising at least one device as described herein.

Embodiments of the invention are shown and illustrated in the following figures:

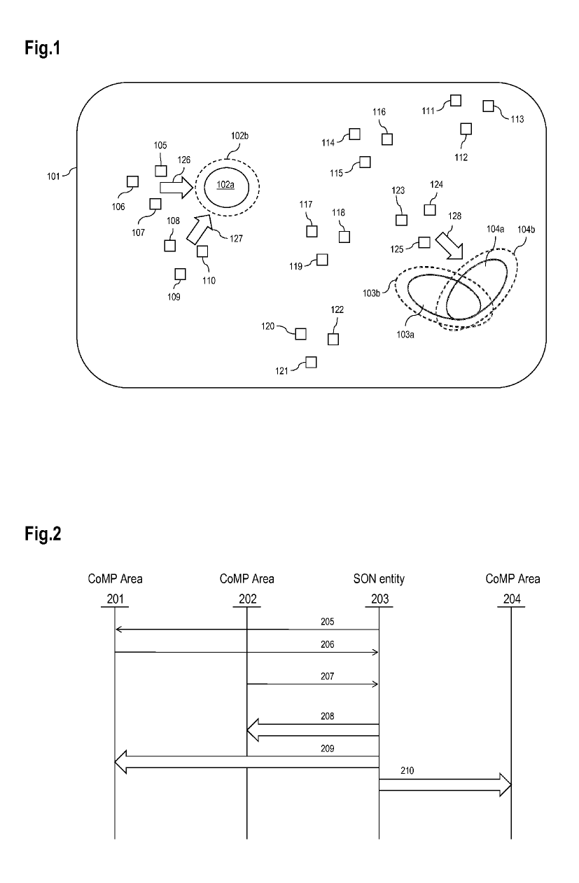

FIG. 1 shows a schematic diagram comprising a cellular network with several CoMP areas, which absorb overload traffic from adjacent radio cells;

FIG. 2 shows a schematic diagram visualizing communication between several (potential) CoMP areas and a centralized network component (SON entity).

This approach suggests initializing CoMP transmission only with regard to at least one portion of the network, wherein such at least one portion may show a significant amount of traffic.

The portion of the network for which CoMP transmission is (to be) applied is also referred to as cooperation area or CoMP area. Each CoMP area may comprise several base stations (e.g., NodeBs, eNBs or the like) or cells, wherein one of these several base stations may provide a centralized functionality of a central unit (CU). The base station to provide such CU functionality can be selected prior to or during an actual CoMP area identification process.

The CoMP area may be identified by a centralized network component (also referred to as SON entity), which may utilize various information in order to identify a suitable CoMP area.

Advantageously, the CoMP area supports a higher amount of traffic compared to the collection of single cells. Hence, the CoMP area—preferably in a region of uniformly distributed high traffic—allows not only processing the traffic of the cells that are combined to the CoMP area, but also being able to process traffic of adjacent cells thereby enabling to reduce the load of such adjacent cells. Hence, the CoMP area may absorb at least a portion of the traffic of its adjacent cells, preferably such traffic that occurs in an area around a border between the adjacent cell and the CoMP area.

Therefore, setting up CoMP areas based on information available to the centralized network component allows the network to cope with a significantly higher amount of traffic compared to the single cell scenario with no such CoMP areas.

Advantageously, the high processing effort and backbone traffic required for CoMP transmission is accepted for such CoMP area, because of the significant overall improvement of traffic processing and in particular because of the increasing capacity that would otherwise not be possible to be provided without setting up additional hardware.

The approach provided is also efficient regarding load changes: The CoMP areas can be set up and released dynamically; thus, highly concentrated temporary traffic can be processed in a flexible way.

Hence, increasing the HO range of the CoMP area traffic can be absorbed from other overloaded cells so that these cells will be able to serve their remaining mobile terminals (UEs) in a single cell transmission mode.

FIG. 1 shows a schematic diagram comprising a cellular network 101 with CoMP areas 102a to 104a, which absorb overload traffic from adjacent radio cells 105 to 125. Also, FIG. 1 visualizes increased handover (HO) ranges 102b to 104b for the CoMP areas 102a to 104a. Due to these increased HO ranges 102b to 104b, the load is shifted towards the CoMP areas 102a to 104a. This is indicated by arrows 126 to 128.

In each CoMP area 102a to 104a, a limited number of eNBs are switched into CoMP mode thereby increasing the capacity of this CoMP area. Hence, in case the surrounding cells are overloaded, load balancing can be conducted via handover towards the cells that are in CoMP mode, i.e. the CoMP area. The UEs of the adjacent cells 105, 107, 108, 110, 125 may be handed over to the cells of the CoMP areas 102a to 104a, preferably until the load of the cells is distributed and all UEs could be served either by the single base stations 105 to 125 or by the CoMP areas 102a to 104a.

Due to fact that the network capacity is increased in the CoMP areas 102a to 104a, which are then less occupied, previous load balancing parameter settings (e.g. HO thresholds) may have to be adapted.

In case the traffic further increases, additional cells could be switched to CoMP mode, which might eventually result in a network-wide CoMP transmission. On the other hand, if traffic load decreases and falls below a predefined threshold, the CoMP mode can gradually be switched off for one CoMP area after the other (or for several if not all CoMP areas at once) thereby adjusting the CoMP processing to the actual traffic load.

Hence, the approach provided combines CoMP transmission and load balancing and it suggests a smooth transition between barely to fully loaded network conditions, thereby adjusting and thus reducing (or minimizing) the considerable efforts required for CoMP transmission.

A SON aspect of the CoMP transmission could in particular be described as follows:

One exemplary implementation of the proposed concept comprises switching specific predefined cells into CoMP mode. However, an improved or optimized solution may determine CoMP hot spots (areas of increased traffic) based on current load conditions as well as on possible capacity gains of CoMP areas. In addition, a size of a CoMP area can be selected or adjusted according to the number of cells that define the actual CoMP area.

Pursuant to the example shown in FIG. 1, the CoMP area 102a is smaller than CoMP areas 103a, 104a. Basically, any subset of cells could be utilized as a CoMP area, wherein an overall smallest number of cells in CoMP mode that cope with the traffic of the network 101 may indicate a preferable solution as the processing effort and traffic overhead for CoMP trans-mission is adjusted to a minimum, but still enough CoMP transmission is provided for the network 101 to cope with the emerging traffic.

Such a preferred solution can be derived by a global approach utilizing an overall knowledge of load conditions for the cells of the network as well as utilizing, e.g., achievable capacity gains for each possible subset of cooperating cells.

Furthermore, the approach suggested allows determining CoMP transmission gains with regard to different areas of the network. CoMP gains may depend on many factors, e.g., inter cell site distance (which determines to what extend the system is limited by interference or noise) or local shadowing conditions between cell sites.

The centralized network component (SON entity) could be provided that determines which set(s) of CoMP areas suit(s) a particular traffic load situation or condition of the network.

In order for the centralized network component to decide which CoMP area(s) to be triggered, information is needed
from the cells that are capable of joining a CoMP area
regarding capacity gains for each constellation of potential or promising CoMP areas.

For this purpose, messages can be defined that may be exchanged via an X2-interface or via an S1-interface (e.g., in an LTE environment):
1) A set of cells that are potentially combined as a CoMP area may be identified and thus corresponding information is conveyed towards the centralized network component (e.g., a radio resource manager, RRM):
   CoMP set [cell ID 1, cell ID 2, cell ID i, . . . ]:
      CoMP SET (ID1 ID2 IDi . . . )
2) For all cells (eNBs), a capacity CAP0 of the respective cell is conveyed towards the centralized network component. The capacity relates to the cell's single cell mode.
3) The capacity of the CoMP set (defined above), i.e. the set of cells being in CoMP mode can be conveyed towards the centralized network component. The capacity is conveyed per cell, i.e. CAP1, CAP2, etc.
   It is noted that different CoMP modes are feasible, hence different messages conveying the capacities per CoMP mode may be provided. CoMP modes may be: Fast cell selection (FCS), coordinated beam forming (CB), joint preceding (JP).
4) A current load per cell can be conveyed towards the centralized network component: LOAD(cell i), LOAD(cell j),

For the CoMP set there might be predefined sets of cell IDs so that not all combinations of CoMP areas may have to be evaluated. These predefined sets could be defined and/or changed by SON, in particular becoming aware of certain CoMP sets that provide a high capacity gain and thus significantly improve the performance of the network.

Information regarding the capacity of the CoMP mode may be provided as relative values, whereas for the optimization to be conducted an absolute value regarding the improvement (e.g., extra capacity) due to CoMP transmission may be derived from the relative values. This can be achieved in case at least the single cell capacity is provided in absolute values.

In addition, the centralized network component (SON entity) may request certain CoMP sets to obtain feedback regarding their capacity (CAP messages). This could be achieved via the following capacity request message:
CAP REQ (ID1, ID2, IDi)

In addition, sets of cooperating cells may need to exchange information in order to organize the CoMP area. This could be achieved via the following message:
CoMP setup (ID1, ID2, IDi)

As a further task, the CoMP capacity gains could be determined before they are sent to the centralized network component. In this regard, the following options could be considered:
a) Fixed predefined values can be used, such values may, e.g., depend on a size of the CoMP area.
b) Key performance indicators (KPIs) could be used, which may have been previously measured or determined when the same set of cells were in CoMP mode. This may provide good indication about possible gains, but requires that the same set has been in CoMP mode before.
c) Another accurate approach comprises measurements of the set of cells, i.e. to switch to CoMP mode and measure the achievable CoMP performance in a particular CoMP area. This might be useful for system setup purposes and/or if eNBs are added.
d) Furthermore, other parameters available at eNBs could be used to derive an expectation value for potential CoMP gains. As an example, available RSRP measurements for (all) active UEs and for, e.g., the three strongest cells may be utilized to derive the CoMP gains achievable by canceling these interferers. Hence, the CoMP capacity gain is calculated, which compares mean SINR values after CoMP with values of single cell SINR (comparison of SINR CDFs).

The last aspect might lead to different message extensions, defining the required request messages from the centralized network component or the delivered feedback messages.

It is noted that CoMP transmission could be regarded as a particular example used in the solution presented herein. In particular, any approach changing (increasing or decreasing) a capacity or redistributing, e.g., throughput from mobile terminals located at the cell edge to mobile terminals located at the cell center UEs—can be used accordingly.

FIG. 2 shows a schematic diagram visualizing communication between several (potential) CoMP areas 201, 202, 204 and a centralized network component 203 (SON entity).

The centralized network component 203 may send a request message 205 towards the CoMP area 201 to obtain information regarding the potential gain and/or capacity of this CoMP area 201 and/or the capacities of the cells that are combined in this CoMP area 201. The CoMP area 201 may process this request determining the information requested and provide it via a message 206 back to the centralized network component 203.

As an alternative, the CoMP area 202 may—without being triggered by the centralized network component 203—convey information 207 about its gain, capacity and/or load situation (optionally also with regard to the single cells of the CoMP area).

Although not shown in FIG. 2, the centralized network component 203 may request capacity information from particular single cells as well in order to determine, e.g., whether or not it may be useful to add such cell to a CoMP area or to set up a CoMP area adjacent to such cell.

In the example shown in FIG. 2, the centralized network component 203 then adjusts the CoMP areas 201, 201 and 204 via messages 208 to 210. It is noted that the CoMP area 204 may be set up due to information from adjacent cells or CoMP areas as well, because it may be indicated that beneficial effects regarding load balancing may occur in case CoMP area 204 is established. Of course, this can also be determined by requesting the (potential) CoMP area 204 to provide information regarding a gain, capacity or load situation.

It is further noted that each CoMP area may comprise several cells, wherein one of these cells comprises a functionality of a central unit. For example, communication with the centralized network component 203 and the respective CoMP area may be conducted via such central unit of the CoMP area.

It is noted that the structure or components shown in FIG. 1 and FIG. 2 could be implemented by a person skilled in the art as various physical units, wherein the eNBs or the centralized network function or component could be realized as at least one logical entity that may be deployed as program code, e.g., software and/or firmware, running on a processing unit, e.g., a computer, microcontroller, ASIC, FPGA and/or any other logic device.

The functionality described herein may be based on an existing component of a (wireless) network, which is extended by means of software and/or hardware. The eNB mentioned herein could also be referred to as any base station pursuant to any communication standard.

The eNB, the base station or the centralized network component may each comprise at least one physical or logical processing unit that is arranged for adjusting a coordinated multipoint transmission of cells of the network based on information provided by the network and/or by said cells.

### LIST OF ABBREVIATIONS

BS Base Station
CDF Cumulative Distribution Function
CoMP Coordinated Multi Point
CU Central Unit
eNB evolved Node B
ID Identification/Identifier
JP Joint Processing
KPI Key Performance Indicator
LTE Long Term Evolution
LTE-A LTE-Advanced
MS Mobile Station
NB Node B
OFDM Orthogonal Frequency Division Multiplexing
OFDMA Orthogonal Frequency Division Multiple Access
RRM Radio Resource Manager
RSRP Reference Signal Received Power
SINR Signal Interference to Noise Ratio
SL System Level
SON Self Optimizing Network
UE User Equipment

1. A method for data processing in a network,
wherein a centralized network function adjusts a coordinated multipoint transmission of cells of the network
based on information provided by the network and/or by said cells.

2. The method according to claim 1, wherein the centralized network function adjusts a coordinated multipoint transmission by adjusting at least one coordinated multipoint area.

3. The method according to claim 2, wherein each coordinated multipoint area comprises at least two cells.

4. The method according to claim 2, wherein load balancing is conducted between the at least one coordinated multipoint area and its adjacent cells.

5. The method according to claim 2, wherein the at least one coordinated multipoint area is adjusted based on network gains.

6. The method according to claim 1, wherein the information comprises at least one of the following:
a current load situation of a cell;
a current load situation of a coordinated multipoint area;
a previous load situation of a cell;
a previous load situation of a coordinated multipoint area;
a potential capacity gain of a coordinated multipoint area;
a size of a coordinated multipoint area;
a set of cells that has been combined or could be combined as a coordinated multipoint area.

7. The method according to claim 1, wherein the information is determined by a CoMP area prior to conveying the information to the centralized network function.

8. The method according to claim 1, wherein the information is conveyed towards the centralized network function, in particular via an X2 interface or via an SI interface.

9. The method according to claim 1, wherein the coordinated multipoint transmission is adjusted based on predefined coordinated multipoint areas.

10. The method according to claim 1, wherein the centralized network function requests feedback from cells of a coordinated multipoint area.

11. The method according to claim 1, wherein the cells of a coordinated multipoint area exchange information for organizing the coordinated multipoint area.

12. A device for data processing in a network comprising or being associated with a processing unit that is arranged to execute the following step:
a coordinated multipoint transmission of cells of the network is adjusted based on information provided by the network and/or by said cells.

13. The device according to claim 12, wherein said device is associated with at least one centralized network function or at least one cell.

14. The device according to claim 12, wherein said device is associated with a radio resource manager of an LTE network.

15. A communication system comprising at least one device according to claim 12.
